(19) United States
(12) Patent Application Publication
(10) Pub. No.: US 2015/0302340 A1
(43) Pub. Date: Oct. 22, 2015

(54) METHODS AND SYSTEMS FOR RECOMMENDING CROWDSOURCING TASKS

(71) Applicants: Xerox Corporation, Norwalk, CT (US); Singapore Management University, Singapore (SG)

(72) Inventors: Koustuv Dasgupta, Bangalore (IN); Deepthi Chander, Cochin (IN); Shih-Fen Cheng, Singapore (SG); Archan Misra, Singapore (SG); Chen Cen, Singapore (SG)

(21) Appl. No.: 14/255,983

(22) Filed: Apr. 18, 2014

(51) Int. Cl. G06Q 10/06; H04W 4/02; G06Q 50/00; G06Q 30/02

(52) U.S. Cl. CPC G06Q 10/063114; G06Q 30/0207; H04W 4/028; G06Q 50/01

(57) ABSTRACT

Methods and systems for recommending crowdsourcing tasks. A path traversed by a crowdworker, from one or more crowdworkers, is predicted, based on at least one of a historical data associated with the crowdworker or an input provided received from the crowdworker. The path traversed by the crowdworker comprises a first set of spatiotemporal values associated with the location of the crowdworker. One or more task attributes associated with the one or more crowdsourcing tasks are determined. The one or more task attributes comprise at least one of a second set of spatiotemporal values associated with the one or more crowdsourcing tasks, or rewards associated with the one or more crowdsourcing tasks. A set of crowdsourcing tasks is recommended based on at least the predicted path followed by each of the one or more crowdworkers and the one or more tasks attributes associated with the one or more crowdsourcing tasks.

### TECHNICAL FIELD

The presently disclosed embodiments are related, in general, to crowdsourcing. More particularly, the presently disclosed embodiments are related to methods and systems for recommending crowdsourcing tasks for one or more crowdworkers.

### BACKGROUND

Crowdsourcing has emerged as a convenient and an economical method for organizations to outsource certain tasks, which require human involvement. For example, tasks such as digitization of handwritten documents, labeling of images, anomaly detection in videos, and so on, may be uploaded by a requester on one or more crowdsourcing platforms. Crowdworkers associated with the crowdsourcing platforms may attempt such tasks.

In addition, the crowdsourcing may enable the requester to leverage lifestyle-driven movement patterns of the crowdworkers to get the tasks done. For example, the requesters may request the crowdworkers to provide the details about queuing delays at movie theatres, about holiday-shopping hours, or about discounts on a set of shops in a shopping-district, while the crowdworkers are traversing for performing their day-to-day activities. Typically, in such scenarios, the crowdworkers may specify the planned itineraries in advance, and the crowdsourcing platform may recommend the crowdsourcing tasks based on the planned itineraries of the individual crowdworker.

### SUMMARY

According to embodiments illustrated herein, there is provided a method for recommending crowdsourcing tasks for one or more crowdworkers. The method includes predicting a path traversed by a crowdworker, from the one or more crowdworkers, based on at least one of a historical data associated with the crowdworker or an input received from the crowdworker. The predicted path traversed by the crowdworker comprises a first set of spatiotemporal values associated with location of the crowdworker. The method further includes determining one or more task attributes associated with one or more crowdsourcing tasks. The one or more task attributes comprise at least one of a second set of spatiotemporal values associated with the one or more crowdsourcing tasks, rewards associated with the one or more crowdsourcing tasks, or a number of crowdworkers required to perform each of the one or more crowdsourcing task. The method further includes recommending a set of crowdsourcing tasks, from the one or more crowdsourcing tasks, for the crowdworker, based on at least the predicted path followed by each of the one or more crowdworkers and the one or more tasks attributes associated with the one or more crowdsourcing tasks. The method is performed by one or more processors.

According to embodiments illustrated herein, there is provided a method implementable in a crowdsourcing platform. The method includes predicting a path traversed by a crowdworker, from one or more crowdworkers, based on at least one of a historical data associated with the crowdworker or an input received from the crowdworker. The predicted path traversed by the crowdworker comprises a first set of spatiotemporal values associated with location of the crowdworker. The method further includes receiving one or more task attributes associated with one or more crowdsourcing tasks. The one or more task attributes comprise at least one of a second set of spatiotemporal values associated with the one or more crowdsourcing tasks, rewards associated with the one or more crowdsourcing tasks, or a number of crowdworkers required to perform each of the one or more crowdsourcing task. The method further includes presenting at least one of a set of crowdsourcing tasks, from the one or more crowdsourcing tasks, for the crowdworker, rewards earned by the one or more crowdworkers, a degree of completeness of the set of crowdsourcing tasks, based on at least the predicted path followed by each of the one or more crowdworkers and the one or more tasks attributes associated with the one or more crowdsourcing tasks. The method is performed by one or more processors.

According to embodiments illustrated herein, there is provided a system for recommending crowdsourcing tasks for one or more crowdworkers. The system includes one or more processors operable to predict a path traversed by a crowdworker, from the one or more crowdworkers, based on at least one of a historical data associated with the crowdworker or an input received from the crowdworker. The predicted path traversed by the crowdworker comprises a first set of spatiotemporal values associated with location of the crowdworker. The one or more processors are further operable to determine one or more task attributes associated with one or more crowdsourcing tasks. The one or more task attributes comprise at least one of a second set of spatiotemporal values associated with the one or more crowdsourcing tasks, rewards associated with the one or more crowdsourcing tasks, or a number of crowdworkers required to perform each of the one or more crowdsourcing task. The one or more processors are further operable to recommend a set of crowdsourcing tasks, from the one or more crowdsourcing tasks, for the crowdworker, based on at least the predicted path followed by each of the one or more crowdworkers and the one or more tasks attributes associated with the one or more crowdsourcing tasks.

According to embodiments illustrated herein, there is provided a computer program product for use with a computer. The computer program product includes a non-transitory computer readable medium. The non-transitory computer readable medium stores a computer program code for recommending crowdsourcing tasks for one or more crowdworkers. The computer program code is executable by one or more processors to predict a path traversed by a crowdworker, from the one or more crowdworkers, based on at least one of a historical data associated with the crowdworker or an input received from the crowdworker. The predicted path traversed by the crowdworker comprises a first set of spatiotemporal values associated with location of the crowdworker. The computer program code is further executable by the one or more processors to determine one or more task attributes associated with one or more crowdsourcing tasks. The one or more task attributes comprise at least one of a second set of spatiotemporal values associated with the one or more crowdsourcing tasks, rewards associated with the one or more crowdsourcing tasks, or a number of crowdworkers required to perform each of the one or more crowdsourcing task. The computer program code is further executable by the one or more processors to recommend a set of crowdsourcing tasks, from the one or more crowdsourcing tasks, for the crowdworker, based on at least the predicted path followed by each of the one or more crowdworkers and the one or more tasks attributes associated with the one or more crowdsourcing tasks.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a block diagram illustrating an application server, in accordance with at least one embodiment;

FIG. 3 is a flowchart illustrating a method for recommending one or more crowdsourcing tasks to the crowdworkers, in accordance with at least one embodiment;

FIG. 4 is a map diagram illustrating the recommendation of the crowdsourcing tasks, in accordance with at least one embodiment; and

FIG. 5 is a flowchart illustrating a method for updating one or more task attributes, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

“Crowdsourcing” refers to distributing tasks (hereinafter, also referred to as crowdsourcing tasks) by soliciting the participation of loosely defined groups of individual crowdworkers. A group of crowdworkers may include, for example, individuals responding to a solicitation posted on a certain website such as, but not limited to, Amazon Mechanical Turk, Crowd Flower, or Mobile Works.

A “crowdsourcing platform” refers to a business application, wherein a broad, loosely defined external group of people, communities, or organizations provide solutions as outputs for any specific business processes received by the application as inputs. In an embodiment, the business application may be hosted online on a web portal (e.g., crowdsourcing platform servers). Examples of the crowdsourcing platforms may include, but are not limited to, Amazon Mechanical Turk, Crowd Flower, or Mobile Works.

A “crowdworker” refers to a workforce/worker(s) that may perform one or more tasks that generate data that contributes to a defined result. With reference to the present disclosure, the crowdworker(s) includes, but is not limited to, a satellite center employee, a rural business process outsourcing (BPO) firm employee, a home-based employee, or an internet-based employee. Hereinafter, the terms “crowdworker”, “worker”, “remote worker”, “crowdsourced workforce”, and “crowd” may be used interchangeably. In an embodiment, the crowdworker may perform the crowdsourcing tasks while he/she traverses different paths for performing day-to-day activities. The crowdworker may perform the crowdsourcing tasks using various types of devices, such as, but not limited to, a laptop, a mobile phone, a PDA, a tablet, a phablet, and the like.

A “crowdsourcing task” refers to a piece of work, an activity, an action, a job, an instruction, or an assignment to be performed. Crowdsourcing tasks may necessitate the involvement of one or more crowdworkers. Examples of the tasks may include, but are not limited to, providing queuing delay information at various places (e.g., theatres, shopping malls, traffic intersections, etc.), providing discount information for a set of shops in a shopping district, providing information about rush at the various places, image/video/text labelling/tagging/categorisation, data entry, product description writing, product review writing, address look-up, survey completion, consumer feedback, or targeted photography (e.g., of product placement). It will be apparent to a person skilled in the art that various other types of information about the locations, traversed by the crowdworkers, may also be requested by the requesters through the crowdsourcing tasks.

A “historical data” refers to a repository of one or more activities previously performed by the one or more crowdworkers. For example, the historical data may include information pertaining to the paths previously traversed by the crowdworkers. For example, the historical data may include information pertaining to location of the crowdworkers at different time intervals, on different days of a week. In an embodiment, the historical data pertaining to the crowdworkers may be received from various types of location tracking services known in the art.

A “path” refers to information pertaining to movement/navigation of the crowdworkers from a first location to a second location. In an embodiment, a path that the crowdworker may follow/traverse may be predicted based on historical data associated with the crowdworker. In an embodiment, the historical data may include information pertaining to paths previously traversed by the crowdworkers. The predicted path may include the prediction of the location of the crowdworkers at various time instants.

A “first set of spatiotemporal values” refers to a set of parameters that correspond to a relation between the location of the crowdworker on a path with respect to time instants. In an embodiment, the first set of spatiotemporal values comprises a series of tuples in the form of <location, timestamp> that depict the location of the crowdworkers at different timestamps. In an embodiment, the values of the first set of spatiotemporal values may be determined based on at least one of the historical data or an input provided by the crowdworkers.

A “second set of spatiotemporal values” refers to a set of parameters that corresponds to location constraints and time constraints associated with the crowdsourcing tasks. The location constraint associated with the crowdsourcing tasks may refer to location that a crowdworker must possess to complete the crowdsourcing tasks. The time constraint associated with the crowdsourcing tasks may refer to a time interval within which the crowdsourcing tasks should be completed. In an embodiment, the requester may provide the information pertaining to the second set of spatiotemporal values associated with the crowdsourcing tasks.

“One or more tasks attributes” refer to one or more parameters associated with the crowdsourcing tasks. In an embodiment, the one or more task attributes may include, but are not limited to, the second set of spatiotemporal values associated with the crowdsourcing tasks, rewards associated with the crowdsourcing tasks, frequency/recurrence of the crowdsourcing tasks, and a number of crowdworkers who required to perform one crowdsourcing task.

“Reward” associated with the crowdsourcing tasks refers to at least one of the rewards earned by the crowdworker for performing the one or more crowdsourcing tasks or the rewards earned by a crowdsourcing platform when the crowdworker performs the one or more crowdsourcing tasks. In an embodiment, the reward may be in the monetary form (e.g., cash). In an alternate embodiment, the reward may include other forms of incentive such as, but not limited to, gift cards, gift coupons, and lottery tickets. Further, in an embodiment, the reward associated with the tasks may correspond to strengthening the relationship between the crowdworkers and the requesters, or the prospects of better rewards on completion of the tasks.

A “first threshold value” corresponds to a threshold value of distance, provided by the crowdworkers. In an embodiment, the crowdworkers may provide the first threshold value to indicate the maximum deviation, from the path that the crowdworkers may traverse to perform the crowdsourcing tasks.

A “second threshold value” corresponds to a threshold value of time, provided by the crowdworkers. In an embodiment, the crowdworkers may provide the second threshold value to indicate the maximum overhead time that the crowdworker may manage to take out of the travel time to perform the crowdsourcing tasks. In an embodiment, the travel time corresponds to a time taken by the crowdworker to traverse from a first location to a second location. For example, a crowdworker usually consumes 1 hour to traverse from the first location to the second location. If the second threshold value is 15 minutes, the crowdworker is willing to reach the second location with a delay of 15 minutes (i.e., total travel time from the first location to the second location is 1 hour 15 minutes). In an embodiment, the overhead of 15 minutes may include time to travel to the location at which the crowdsourced task needs to be performed and time needed to complete the task.

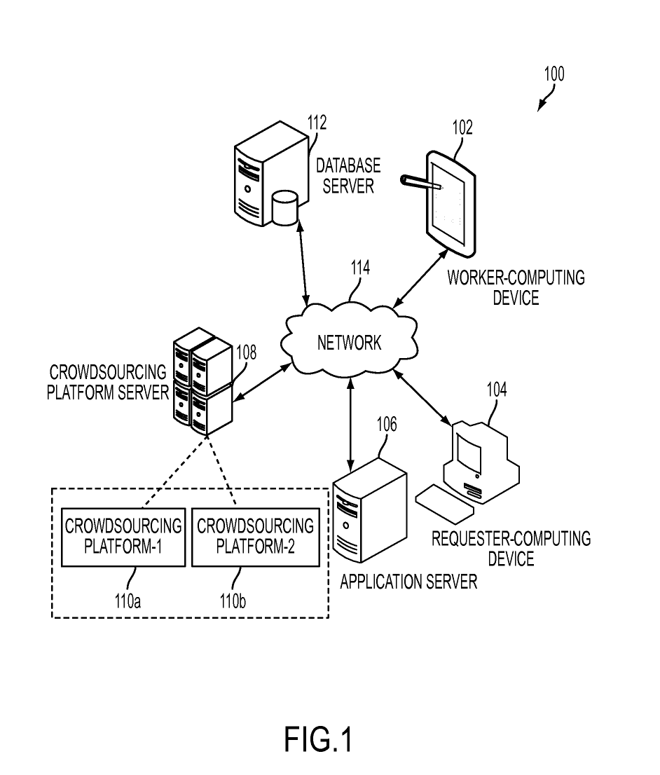

FIG. 1 is a block diagram illustrating a system environment 100 in which various embodiments may be implemented. The system environment 100 includes a worker-computing device 102, a requester-computing device 104, an application server 106, a crowdsourcing platform server 108, a database server 112, and a network 114. Various devices in the system environment 100 (e.g., the worker-computing device 102, the requester-computing device 104, the application server 106, the crowdsourcing platform server 108, and the database server 112) may be interconnected over the network 114.

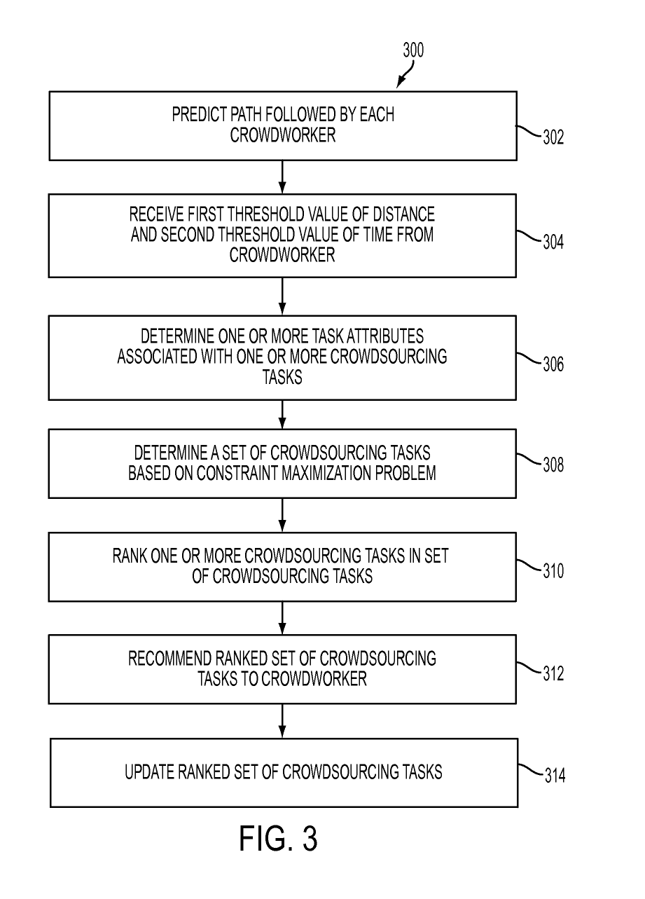

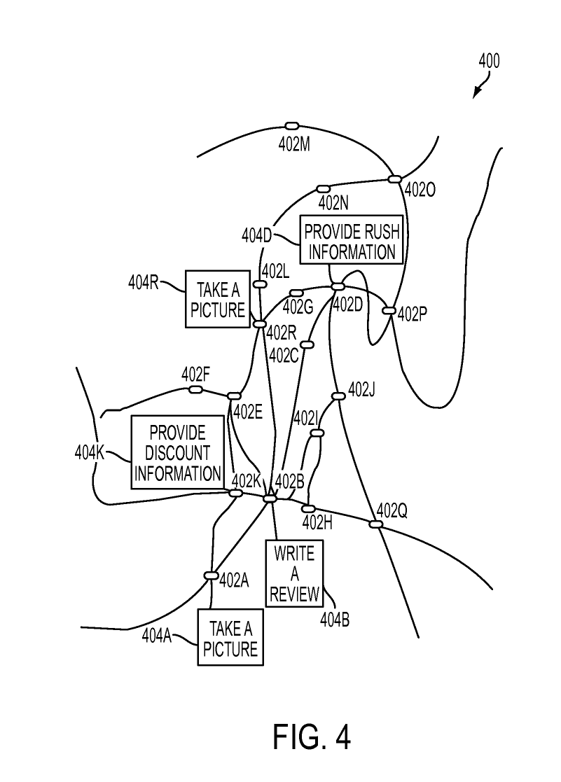

The worker-computing device 102 refers to a computing device, used by a crowdworker, to perform one or more crowdsourcing tasks. In an embodiment, the crowdworker may receive the one or more crowdsourcing tasks on a display associated with the worker-computing device 102. Subsequently, the crowdworker may submit the responses to the one or more crowdsourcing tasks using the worker-computing device 102. The crowdworker may provide the responses using one or more input devices (e.g., keyboard, touch-interface, gesture-recognition, etc.) associated with the worker-computing device 102. In an embodiment, the worker-computing device 102 includes a location tracking device (e.g., GPS), using which the location of the crowdworker may be tracked. The tracked information may be utilized for recommending a set of crowdsourcing tasks to the crowdworker. Further details about the recommendation of the set of crowdsourcing tasks have been provided in conjunction with the FIG. 3 and FIG. 4. The worker-computing device 102 may include a variety of computing devices, such as a laptop, a personal digital assistant (PDA), a tablet computer, a smartphone, a phablet, and the like.

The requester-computing device 104 may refer to a computing device, used by the requester, to upload the one or more crowdsourcing tasks on the crowdsourcing platform server 108. In an embodiment, the requester may access the crowdsourcing platform server 108 to upload the one or more crowdsourcing tasks. In an embodiment, along with uploading of the one or more crowdsourcing tasks, the requestor computing device 104 may upload information pertaining to the one or more crowdsourcing tasks. For example, if the crowdsourcing tasks correspond to providing the information pertaining to the queuing delay at a shopping mall, the requester may provide various details to the crowdsourcing platform server 108, for example, the name of shopping mall, address of the shopping mall, the time constraint for which the delay information is required, and the like. In an embodiment, the requester may utilize the requester-computing device 104 to provide the one or more tasks attributes associated with the crowdsourcing tasks. For example, the requesters may provide the information about the second set of spatiotemporal values (i.e., the location constraints and the time constraints) and the rewards associated with the crowdsourcing tasks. The requester-computing device 104 may include a variety of computing devices, such as a desktop, a computer server, a laptop, a personal digital assistant (PDA), a tablet computer, and the like.

The application server 106 refers to a computing device that determines the set of crowdsourcing tasks from the one or more crowdsourcing tasks. In an embodiment, the application server 106 predicts a path that may be traversed by the one or more crowdworkers. The application server 106 may predict the path based on a historical data associated with each of the one or more crowdworkers. In an embodiment, the path is predicted based on an input received from the one or more crowdworkers. Further, the application server 106 may receive the one or more task attributes and the corresponding one or more crowdsourced tasks from the requester-computing device 104. In an embodiment, the application server 106 creates a constraint maximization problem that considers the predicted path that may be traversed by each of the one or more crowdworkers, and the one or more task attributes associated with the one or more crowdsourcing tasks. Based on the constraint maximization problem, the application server 106 may determine the set of crowdsourcing tasks for each of the one or more crowdworkers. Further illustrations and details about the determination of the set of crowdsourcing tasks have been discussed in conjunction with the FIG. 3 and FIG. 4. In an embodiment, the application server 106 may rank the set of crowdsourcing tasks based on the constraint maximization problem. Further, the application server 106 may dynamically update the set of crowdsourcing tasks based on a real time location of the crowdworker. The application server 106 may be realized through various types of application servers such as, but not limited to, Java application server, .NET framework, and Base4 application server.

The crowdsourcing platform server 108 may refer to a device or a computer that hosts one or more crowdsourcing platforms (e.g., crowdsourcing platform-1 110a and crowdsourcing platform-2 110b, depicted in the system environment 100). In an embodiment, the crowdsourcing platform server 108 may receive the recommendation of the crowdsourcing tasks for the one or more crowdworkers from the application server 106. Thereafter, the crowdsourcing platform server 108 may communicate the crowdsourcing tasks to the one or more crowdworkers based on the recommendation. The crowdsourcing platform server 108 may communicate the crowdsourcing tasks over the network 114. Subsequently, the one or more crowdworkers may access the crowdsourcing tasks using the worker-computing device 102, and may submit a final response for the crowdsourcing tasks to the crowdsourcing platform server 108. The crowdsourcing platform server 108 may be realized through various types of application servers such as, but not limited to, Java application server, .NET framework, and Base4 application server.

The database server 112 may refer to a device or a computer that maintains a repository of tasks assigned to the one or more crowdworkers. In an embodiment, the database server 112 may also store the historical data, pertaining to the one or more crowdworkers, which includes the information pertaining to the previously traversed paths by the one or more crowdworkers. In addition, the database server 112 may store the one or more task attributes associated with the one or more crowdsourcing tasks. In an embodiment, the database server 112 may receive a query from at least one of the application server 106 or the crowdsourcing platform server 108 to retrieve at least the historical data associated with the one or more crowdworkers. For querying the database server 112, one or more querying languages may be utilized such as, but not limited to, SQL, QUEL, DMX and so forth. Further, the database server 112 may be realized through various technologies such as, but not limited to, Microsoft® SQL server, Oracle, and My SQL. In an embodiment, the application server 106 or the crowdsourcing platform server 108 may connect to the database server 112 using one or more protocols such as, but not limited to, ODBC protocol and JDBC protocol.

It will be apparent to a person skilled in the art that the functionalities of the database server 112 may be incorporated into the application server 106, without departing from the scope of the disclosure. Further, the functionalities of the application server 106 and the database server 112 may, collectively, be incorporated into the crowdsourcing platform server 108.

The network 114 corresponds to a medium through which content and messages flow between various devices of the system environment 100 (e.g., the worker-computing device 102, the requester-computing device 104, the application server 106, the crowdsourcing platform server 108, and the database server 112). Examples of the network 114 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 114 in accordance with various wired and wireless communication protocols such as Transmission Control Protocol and Internet Protocol (TCP/IP), User Datagram Protocol (UDP), and 2G, 3G, or 4G communication protocols.

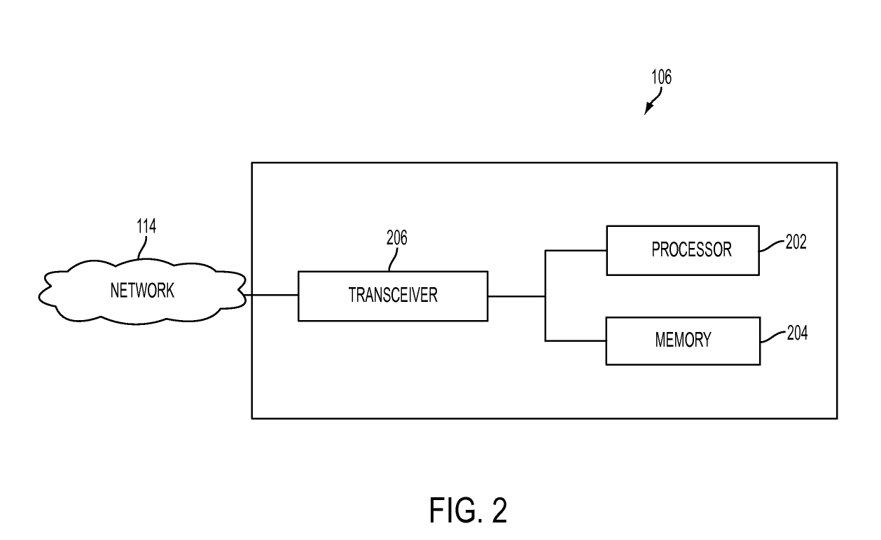

FIG. 2 is a block diagram illustrating the application server 106, in accordance with at least one embodiment. The application server 106 includes a processor 202, a memory 204, and a transceiver 206.

The processor 202 is coupled to the memory 204 and the transceiver 206. The processor 202 includes suitable logic, circuitry, and/or interfaces that are operable to execute one or more instructions stored in the memory 204 to perform predetermined operation. The memory 204 may be operable to store the one or more instructions. The processor 202 may be implemented using one or more processor technologies known in the art. Examples of the processor 202 include, but are not limited to, an X86 processor, a RISC processor, an ASIC processor, a CISC processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person having ordinary skills in the art that the one or more instructions stored in the memory 204 enables the hardware of the application server 106 to perform the predetermined operation.

The transceiver 206 transmits and receives messages and data to/from various components of the system environment 100. Examples of the transceiver 206 may include, but are not limited to, an antenna, an Ethernet port, an USB port or any other port that can be configured to receive and transmit data. The transceiver 206 transmits and receives data/messages in accordance with the various communication protocols, such as, TCP/IP, UDP, and 2G, 3G, or 4G communication protocols.

The operation of the application server 106 for recommending the one or more crowdsourcing tasks has been described in conjunction with FIG. 3.

FIG. 3 is a flowchart 300 illustrating a method for recommending one or more crowdsourcing tasks to the one or more crowdworkers, in accordance with at least one embodiment. The flowchart 300 is described in conjunction with FIG. 1 and FIG. 2.

At step 302, a path followed by each of the one or more crowdworkers, is predicted. The processor 202 may predict the path based on the historical data pertaining to paths previously traversed by each of the one or more crowdworkers. In an embodiment, the paths previously traversed by the crowdworkers may be tracked by location tracking services known in the art. For example, the worker-computing device 102 may include a GPS module that enables the tracking of the location of the crowdworker. In an embodiment, the GPS module may periodically transmit the location of the crowdworker. Based on such tracked information, the historical data for each of the one or more crowdworkers may be determined. For example, the historical data may include information that a crowdworker was near location X at 08:00 AM on Monday.

In an embodiment, based on the pattern recognition and statistical techniques known in the art, the processor 202 may predict the paths followed by the crowdworker at various time intervals of different days of a week/month. Further, such predicted information pertaining to the paths followed by the crowdworker may be stored in the database server 112, and the processor 202 may receive such information from the database server 112 at regular intervals. The location of the crowdworker in the predicted paths may be depicted through various ways such as, but not limited to, Cartesian co-ordinates of the location of the crowdworker, a landmark near the location of the crowdworker, latitude-longitude of the location of the crowdworker and so forth.

In an alternate embodiment, the processor 202 may predict the path of each of the one or more crowdworkers based on the input provided by the each of the one or more crowdworkers. In such scenarios, the crowdworker may provide the input (e.g., through input device associated with the worker-computing device 102) that depicts the paths to be traversed by the crowdworker. For example, the crowdworker may provide input that depicts that between Monday and Friday, the crowdworker follow a particular path between particular time intervals (e.g., while commuting to office). Based on such inputs, the processor 202 may predict the path of each of the crowdworkers.

In an embodiment, the predicted path of the crowdworker includes a first set of spatiotemporal values. The first set of spatiotemporal values includes a plurality of tuples in the form of <location, timestamp>, in which the first part of the tuple (i.e., the location) depicts the location of the crowdworker and the second part of the tuple (i.e., the timestamp) depicts the time at which the crowdworker will be at that location.

Table 1 provided below illustrates the path, as predicted by the processor 202, corresponding to a crowdworker:

TABLE 1
Illustration of predicted path for a crowdworker

| | | Location of the | First set of spatiotemporal |
|---|---|---|---|
| Day | Time | crowdworker | value |
| Monday | 8:00 | Location A | <Location A, 08:00> |
| Monday | 8:05 | Location B | <Location B, 08:05> |
| Monday | 8:10 | Location C | <Location C, 08:10> |
| Monday | 8:15 | Location D | <Location D, 08:15> |
| Tuesday | 8:00 | Location E | <Location E, 08:00> |
| Tuesday | 8:05 | Location F | <Location F, 08:05> |
| Tuesday | 8:10 | Location G | <Location G, 08:10> |
| Tuesday | 8:15 | Location H | <Location H, 08:15> |

As depicted in Table 1, the processor 202 predicts the location of the crowdworker at different time instants. For example, the processor 202 predicts that the crowdworker will be at location A at 08:00 hrs. on Monday (represented through the tuple <location A, 08:00>). In a similar way, it can be observed that the processor 202 predicts the location of the crowdworker at 08:00 hrs. on Tuesday as B. As discussed, entries of the Table 1 may be predicted based on at least one of the historical data or the input provided by the crowdworker. In an alternate embodiment, different locations depicted in the Table 1 may correspond to latitude-longitude values of the respective location. It will be understood by a person skilled in the art that though the predicted information about the location of the crowdworker has been depicted only for two days, similar information may be predicted for different days.

At step 304, the processor 202 receives a first threshold value and a second threshold value from each of the one or more crowdworkers. In an embodiment, the first threshold value corresponds to a maximum overhead of distance that the crowdworker may traverse to attempt the crowdsourcing task. The crowdworker may provide the first threshold value in a unit of distance. For example, the crowdworker may provide the first threshold value as 2 KM, which means that the crowdworker is ready to traverse an extra 2 KM, from his/her path, to attempt a crowdsourcing task. In an embodiment, the second threshold value corresponds to a maximum time that the crowdworker may devote to perform the crowdsourcing task. For example, the crowdworker may provide the second threshold value as 15 minutes, which means that the crowdworker may take out 15 minutes from the total travel time to attempt the crowdsourcing task. (e.g., due to detoured path followed to perform the task). It will be apparent to a person skilled in the art that the first threshold value and the second threshold value depicts the willingness of the crowdworker to perform the crowdsourcing tasks, in terms of the constraints imposed on the additional distance/time needed to perform the tasks. The processor 202 may store the first threshold value and the second threshold value corresponding to each of the one or more crowdworkers in the at least one of the memory 204 or the database server 112.

At step 306, the one or more task attributes associated with the one or more crowdsourcing tasks are determined. Prior to determining the one or more task attributes, the processor 202 receives the one or more crowdsourcing tasks from the requestor. The processor 202 determines the one or more task attributes based on the information received from the requester. For example, the requester may provide information pertaining to the rewards/payment associated with the one or more crowdsourcing tasks. In an embodiment, the one or more tasks attributes may include, but are not limited to, a second set of spatiotemporal values, rewards paid to the crowdworkers to perform the crowdsourcing tasks, rewards paid to the crowdsourcing platforms when the crowdworkers perform the crowdsourcing tasks, and a number of crowdworkers required to perform one crowdsourcing task. The second set of spatiotemporal values includes one or more tuples in the form the <location, timestamp> that depicts the location/time constraints to perform the crowdsourcing tasks. For example, if a tuple corresponding to a crowdsourcing task has the value <location A, 10:00>, then the crowdsourcing task needs to be executed at the location A and at the time 10:00 hrs. Rewards paid to the crowdworker correspond to the incentive in the monetary form (e.g., cash). In an alternate embodiment, the reward may include other forms of incentive, such as, but not limited to, gift cards, gift coupons, and lottery tickets. Further, in an embodiment, the reward associated with the tasks may correspond to strengthening the relationship between the crowdworkers and the requesters, or the prospects of better rewards on completion of the tasks. Rewards paid to the crowdsourcing platform may correspond to the incentive provided to the crowdsourcing platform (e.g., by the requester) when the crowdworkers perform the crowdsourcing tasks posted by that requester. It will be apparent to person skilled in the art that other forms of the rewards (as disclosed for the crowdworkers) may also be paid to the crowdsourcing platform, without limiting the scope of the disclosure. Further, the number of the crowdworkers required to perform a crowdsourcing tasks depicts, the count of the crowdworkers that need to perform the crowdsourcing task. For example, the requester may provide, through the one or more task attributes, that at least three crowdworkers need to execute a crowdsourcing task to consider that crowdsourcing tasks to be completed. The processor 202 may store the one or more task attributes in the database server 112.

At step 308, the set of crowdsourcing tasks is determined. The processor 202 determines the set of crowdsourcing tasks, from the one or more crowdsourcing tasks, for each of the one or more crowdworkers. In an embodiment, the processor 202 utilizes at least one of the first set of spatiotemporal values (associated with the predicted path that may be traversed by the crowdworker), the second set of spatiotemporal values (location and time at which a crowd sourced task needs to be attempted), the first threshold value, or the second threshold value to determine a constraint maximization problem. Subsequently, the constraint maximization problem may be solved using linear programming (LP) methods known in the art to determine the set of crowdsourcing tasks for each of the one or more crowdworkers. In an embodiment, the processor 202 compares the first set of spatiotemporal values (as determined in conjunction with the step 302) and the second set of spatiotemporal values (as determined in conjunction with the step 306). Based on such comparison, the processor 202 may determine the set of crowdsourcing tasks that a crowdworker may perform. For example, the processor 202 determines that a crowdsourcing task is available to be performed at location C at 08:10 hrs. on Monday. In such a scenario, the processor 202 may determine that the crowdworker (refer Table 1) is capable to perform the task, since the crowdworker is available at the required location (i.e., location C), at required time (i.e., 08:10 hrs.), and required day (i.e., Monday). In a similar way, corresponding to each of the crowdworkers, the processor 202 determines the set of crowdsourcing tasks by solving the constraint maximization problem.

In an embodiment, the set of crowdsourcing tasks determined for a crowdworker depends on the predicted path, location, the second threshold value, and the first threshold value of the one or more other crowdworkers.

In an embodiment, to solve the constraint maximization problem, for each of the one or more crowdworkers, the processor 202 determines shortest overhead distance, from the available alternative routes, available for the crowdworkers. If the shortest overhead distance is less than the first threshold value associated with a crowdworker, then the processor 202 considers the task for determining the set of tasks for the crowdworker. For example, there are three crowdworkers C₁, C₂, and C₃, and three crowdsourcing tasks T₁, T₂, and T₃. Further, the first threshold value provided by each of the three crowdworkers (i.e., C₁, C₂, C₃) is 5 KM. In such a scenario, Table 2 provided below illustrates the shortest overhead distance to perform the tasks T₁, T₂, and T₃:

TABLE 2
Illustration of the shortest overhead distance to
be traversed by three crowdworkers (C₁, C₂, C₃) to perform
three crowdsourcing tasks (T₁, T₂, T₃)

| | Crowdsourcing | Shortest overhead distance from |
|---|---|---|
| Crowdworker | task | available alternative routes |
| C₁ | T₁ | 2 |
| | T₂ | 3 |
| | T₃ | 6 |
| C₂ | T₁ | 4 |
| | T₂ | 7 |
| | T₃ | 2 |
| C₃ | T₁ | 8 |
| | T₂ | 1 |
| | T₃ | 4 |

It can be observed from Table 2 that for the crowdworker C₁, the processor 202 considers the tasks T₁ and T₂ for determining the set of crowdsourcing tasks. The task T₃ will not be considered for determining the set of crowdsourcing tasks for the crowdworker C₁, since it requires the shortest overhead distance of the 6KM that is more than the first threshold value provided by the crowdworker C₁. In a similar way, for other crowdworkers (i.e., C₂ and C₃), the crowdsourcing tasks, which will be considered for the determination of the set of tasks, are determined. Table 3 illustrates such crowdsourcing tasks for each of the three crowdworkers:

TABLE 3
Illustration of crowdsourcing tasks and respective overhead
distance for three crowdworkers (C₁, C₂, C₃)

| | Crowdsourcing tasks/ |
|---|---|
| Crowdworker | Respective overhead distance |
| C₁ | {T₁, T₂}/{2, 3} |
| C₂ | {T₁, T₃}/{4, 2} |
| C₃ | {T₂, T₃}/{1, 4} |

Subsequently, the processor 202 determines the set of crowdsourcing tasks such that the cumulative overhead distance by all the three crowdworkers is least. For example, if the set of crowdsourcing tasks corresponding to the crowdworkers C₁, C₂, and C₃ are {T₁}, {T₃}, and {T₂}, respectively, then the total overhead distance by the three crowdworker (refer Table 3) will be 5 KM. However, if the set of crowdsourcing tasks corresponding to the crowdworkers C₁, C₂, and C₃ are {T₂}, {T₁}, and {T₃}, respectively, then the total overhead distance covered by the three crowdworker (refer Table 3) will be 10 KM. Thus, in such a scenario, the processor 202 will determine the set of crowdsourcing tasks corresponding to the crowdworkers C₁, C₂, and C₃ as {T₁}, {T₃}, and {T₂}, respectively. It will be apparent to a person skilled in the art that though the illustration has been provided for the case where only one crowdsourcing task has been included for each of the crowdworker, more than one crowdsourcing tasks may also be included for each crowdworker, without limiting the scope of the disclosure. Further, in an embodiment, the constraint maximization problem can be solved such that a single crowdsourcing task may be assigned to more than one crowdworkers.

Further, it can be observed that a task considered for the crowdworker is dependent on the location and predicted path traversed by other crowdworkers, such that cumulative overhead distance by the one or more crowdworkers is minimum. Illustration of such scenario has been provided in conjunction with FIG. 4.

In an embodiment, the processor 202 may utilize below provided equation to ensure that time constraint (i.e. the second threshold value) provided by the crowdworker “k” is not violated:

Σₖ₌₁^{M}Σ_{iεR}_{ₖ}sᵢₖYᵢₖΣ_{iεTask}sᵢzᵢ, (1)

such that

Σᵢ₌₁^{N}Σⱼ₌₁^{N}tᵢⱼxᵢⱼₖ≦Tₖ (2)

where,

sᵢₖ=rewards paid to the crowdworker k visiting the task at location i,

yᵢₖ=1 if crowdworker k visits location i,

sᵢ=reward associated with the crowdsourcing task at location i,

zᵢ=1 if at least one crowdworker visits location i,

Tₖ=second threshold value provided by the crowdworker,

tᵢⱼ=travel time incurred between location i to location j,

xᵢⱼₖ=1, if the crowdworker k traverses the distance between the location i and location j, else,

xᵢⱼₖ=0.

In an embodiment, the processor 202 solves the constraint maximization problem such that collective rewards earned by the one or more crowdworkers capable to perform the one or more crowdsourcing tasks are maximized. It will be apparent to a person skilled in the art that any of the task attributes may be considered while solving the constraint maximization problem, without limiting the scope of the disclosure. For example, the constraint maximization problem may be solved to maximize the reward earned by the crowdsourcing platform server 108.

In an embodiment, the processor 202 may solve the constraint maximization problem using the heuristic techniques, known in the art, to determine the set of crowdsourcing tasks corresponding to each crowdworker. For example, the processor 202 may use a combination of a greedy method and an iterated local search for determining the set of crowdsourcing tasks.

At step 310, the set of crowdsourcing tasks is ranked. The processor 202 ranks the set of crowdsourcing tasks. In an embodiment, corresponding to each crowdworker, the processor 202 ranks the set of crowdsourcing tasks (as determined in conjunction with the step 308) based on at least the one or more task attributes, the first threshold value, or the second threshold value. For example, the processor 202 may determine that for a crowdworker, a first crowdsourcing task requires a first overhead distance and a second crowdsourcing task requires a second overhead distance to be traversed by the crowdworker. Further both, the first overhead distance and the second overhead distance are below the first threshold value of distance provided by the crowdworker. In such a scenario, if the first overhead distance is less than the second overhead distance, then the processor 202 may put the first crowdsourcing task on a higher priority than the second crowdsourcing task. In a similar way, the set of crowdsourcing tasks may be ranked based on additional time that the crowdworker will need to devote to perform the crowdsourcing task.

At step 312, the ranked set of crowdsourcing tasks is recommended to each crowdworker. In an embodiment, the processor 202 may transmit the ranked set of crowdsourcing tasks to the crowdsourcing platform server 108. Subsequently, the crowdsourcing platform server 108 may recommend the crowdsourcing tasks to the crowdworkers. In an embodiment, the processor 202 determines the real-time location of the crowdworker before recommending the set of crowdsourcing tasks. In this way, the scenarios where the crowdworker takes different paths than the predicted paths may be taken care. Further details about this scenario have been discussed below in conjunction with the step 314. The crowdsourcing platform server 108 may recommend the crowdsourcing tasks on the display associated with the worker-computing device 102.

In an embodiment, the set of crowdsourcing tasks is displayed to the crowdworker as a layer on a map. For instance, the crowdworker is navigating from location 1 to location 2 using a route. The crowdworker may be utilizing a navigation application. The navigation application may display a map and the route to the crowdworker. In such a scenario, the set of crowdsourcing tasks may be recommended to the crowdworker on the map.

At step 314, the set of crowdsourcing tasks corresponding to each crowdworker is updated. The processor 202 updates the set of crowdsourcing tasks. In an embodiment, the processor 202 monitors a real time location of each of the one or more crowdworkers to determine whether each crowdworker is traversing the same path as predicted by the processor 202 in step 302. If it is determine that the crowdworker is traversing through a different path, a real time location of the crowdworker is determined. Based on the real time location of the crowdworker, the processor 202 may dynamically update the set of crowdsourcing tasks for a crowdworker. For example, as discussed in conjunction with the step 302, based on the historical data, the processor 202 may have predicted that a crowdworker will be available at the location A at 08:00 Hrs. to take-up a crowdsourcing task. However, it might be possible that the crowdworker takes a different path than the predicted/determined path. In such a scenario, if the processor 202 determines that the location of the crowdworker is different from the location that was predicted, the processor 202 may update the set of crowdsourcing tasks for that crowdworker. Further, in an embodiment, the crowdworkers may themselves update the first threshold values and the second threshold values. In such scenarios, as well, the processor 202 may update the set of crowdsourcing tasks for the crowdworker. The processor 202 may also update the set of crowdsourcing tasks based on the updated values of the one or more task attributes. Further, as the set of crowdsourcing tasks are recommended to the crowdworkers and as those tasks are attempted by the crowdworkers, the available number of crowdsourcing tasks may also change. In such scenarios also, the processor 202 may update the set of crowdsourcing tasks.

In an embodiment, the requester may provide priority order for the crowdsourcing tasks. For example, the requester may specify that the crowdsourcing tasks may first be allocated to students, then to crowdworkers employed in public sector, and then to crowdworkers employed in private sector. It will be apparent to a person skilled in the art that requester may set the priority based on his/her requirement to execute the one or more tasks. In an embodiment, the processor 202 may update the set of crowdsourcing tasks based on the priority order for the crowdsourcing tasks.

FIG. 4 is a map diagram 400 illustrating the recommendation of the crowdsourcing tasks, in accordance with at least one embodiment. The map diagram 400 includes different locations 402A-R interconnected by different paths. Further, the map diagram 400 includes crowdsourcing tasks 404A, 404B, 404K, 404R, and 404D (hereinafter collectively referred to as crowdsourcing tasks 404). The crowdsourcing tasks 404 may include various types of details required to perform the crowdsourcing tasks. FIG. 4 has been described in conjunction with the FIG. 1, FIG. 2, and FIG. 3.

In accordance with the step 302, the path followed by the one or more crowdworkers is predicted. For example, the processor 202 predicts the path followed by two crowdworkers X and Y. As discussed in conjunction with the step 302, the predicted paths followed by the crowdworker include first set of spatiotemporal values. Table 4 illustrates the predicted path followed by the crowdworkers X and Y and associated first set of spatiotemporal values:

TABLE 4
Illustration of predicted paths for two crowdworkers
and associated first set of spatiotemporal values

| | | First Set of |
|---|---|---|
| Crowdworker | Predicted Path Followed | Spatiotemporal Values |
| Crowdworker | Location A → Location B → | <location 402A, 08:00>, |
| X | Location E → Location R → | <location 402B, 08:15>, |
| | Location G → Location D | <location 402E, 08:45>, |
| | | <location 402R, 09:00>, |
| | | <location 402G, 09:15>, |
| | | <location 402D, 09:30> |
| Crowdworker | Location A → Location K → | <location 402A, 08:00>, |
| X | location E → Location R → | <location 402K, 08:15>, |
| | Location G → Location D | <location 402E, 08:45>, |
| | | <location 402R, 09:00>, |
| | | <location 402G, 09:15>, |
| | | <location 402D, 09:30> |
| Crowdworker | Location A → Location B → | <location 402A, 08:00>, |
| Y | Location I → Location J → | <location 402B, 08:15>, |
| | Location D | <location 402I, 09:00>, |
| | | <location 402J, 09:30>, |
| | | <location 402D, 10:00> |

Table 4 illustrates that the predicted path followed by the crowdworker X is such that he/she will be available at location 402A at 08:00 hrs., and will be available at location 402D at 09:30 hrs. Further, it can be observed that the crowdworker X can traverse the path from the location 402A to the location 402D through two different paths. Similarly, it can be observed that the path followed by the crowdworker Y is such that he/she will be available at the location 402A at 08:00 hrs., and will be available at location D at 10:00 hrs. As discussed in conjunction with the step 302, above illustrated paths for the crowdworker X and Y may be predicted based on the historical data pertaining to the respective crowdworker, or based on the input provided by the respective crowdworker. Further, the processor 202 may predict that the path followed by the crowdworker may be different in different days of a week. Such estimations may be made based on pattern matching techniques, as discussed in conjunction with the step 302.

In accordance with the step 304, the processor 202 receives the first threshold value and the second threshold value from the crowdworkers X and Y. As discussed above, the first threshold value and the second threshold value correspond to maximum overhead of distance and time respectively. Table 5 illustrates the first threshold value and the second threshold value associated with the crowdworker X and Y:

TABLE 5
Illustration of the first threshold value and the
second threshold value provided by the crowdworkers

| Crowdworker | First threshold value | Second threshold value |
|---|---|---|
| Crowdworker X | 2 KM | 15 minutes |
| Crowdworker Y | 3 KM | 30 minutes |

In accordance with the step 306, the one or more task attributes associated with the one or more crowdsourcing tasks 404 are determined. As discussed in conjunction with the FIG. 3, the requester may provide the one or more task attributes. With reference to the map diagram 400, Table 6 illustrates the one or more task attributes for the crowdsourcing tasks 404:

TABLE 6
Illustration of one or more task attributes
associated with the crowdsourcing tasks 404

| | Second set of | Rewards paid to | Rewards paid to the |
|---|---|---|---|
| | spatiotemporal | the crowdworker | crowdsourcing platform |
| Task | values | (cents) | (cents) |
| 404A | Location A, | 5 | 2 |
| | 12:00-14:00 | | |
| 404B | Location B, | 50 | 10 |
| | 08:05:09:05 | | |
| 404K | Location K, | 10 | 3 |
| | 08:05:09:05 | | |
| 404 R | Location R, | 15 | 2 |
| | 14:00-15:00 | | |
| 404 D | Location D, | 15 | 5 |
| | 20:00-21:00 | | |

Table 6 illustrates that the requester may provide various types of attributes for each of the crowdsourcing task. For example, as depicted, the crowdsourcing task 404A may have spatiotemporal constraints of <location A, 12:00-14:00> associated with it. That is, the crowdsourcing task 404A needs to be executed at the location A and within the time interval 12:00-14:00 hrs. Further, it can be observed that the rewards paid to the crowdworker to perform the crowdsourcing task 404A is 5 cents, and the rewards paid to the crowdsourcing platform for each completed crowdsourcing task 404A is 2 cents. In a similar way, the requester may provide the one or more task attributes associated with other crowdsourcing tasks, as depicted in Table 6. It will be understood by a person skilled in the art that the attributes depicted in Table 6 are just for illustration purposes and other attributes may be added in the Table 6, without limiting the scope of the disclosure.

In accordance with the step 308, the set of crowdsourcing tasks is determined. As discussed in conjunction with the step 308, the processor 202 may solve the constraint maximization problem to determine the set of crowdsourcing task. That is, the processor 202 may utilize the first set of spatiotemporal values (refer Table 4), second set of spatiotemporal values (refer Table 6), and overhead constraints (refer Table 5) to form the constraint maximization problem. In an embodiment, the processor 202 determines that the crowdworker X can be recommended the crowdsourcing task 404B since the crowdworker X will be available at the location B at the time 08:15 Hrs., and the time interval in which the crowdsourcing task 404B needs to be executed is 08:05 to 09:05 hrs. Further, the processor 202 determines that the crowdworker X may be recommended the crowdsourcing task 404K, since the crowdworker X may take a detour to the location 402E via location 402K. The processor 202 determines that the crowdsourcing task 404K may be recommended to the crowdworker X if the detour results in overhead distance of less than 2 KM (i.e., maximum overhead distance provided by the crowdworker X). It will be understood by a person skilled in the art that since both the tasks (i.e., 404B and 404K) are performed at the same time interval, the crowdworker X may be not available to perform both the tasks. In a similar way, the processor 202 determines that the crowdworker Y may be recommended the crowdsourcing task 404B. In an embodiment, the solution of the constraint maximization problem suggests that the crowdworker X should not be recommended the crowdsourcing task 404B, since otherwise the crowdworker Y may not have any task recommended to him/her, and eventually only one task (i.e., 404B or 404K) will be executed by the crowdworker X. Thus, considering that the rewards to both the crowdworkers are maximized, the processor 202 determines the allocation of the crowdsourcing tasks as illustrated in Table 7:

TABLE 7
Availability of crowdsourcing tasks to different crowdworkers

| Crowdworker | Set of crowdsourcing tasks |
|---|---|
| Crowdworker X | 404K |
| Crowdworker Y | 404B |

It will be understood by a person skilled in the art that though the illustration has been provided only for two crowdworkers and few crowdsourcing tasks 404, the set of crowdsourcing tasks may be determined when the number of crowdsourcing tasks and crowdworker is large. (e.g., in the range of hundreds of thousands).

In accordance with the step 310, the set of crowdsourcing tasks may be ranked. As discussed in conjunction with the step 310, the processor 202 may rank the set of crowdsourcing tasks based on the least overhead distance/time required by the crowdworker X and the crowdworker Y.

In accordance with the step 312, the ranked set of crowdsourcing tasks may be recommended to the crowdworkers X and Y. It will be understood by a person skilled in the art that when the crowdworkers X and Y traverses the path in actual, between the location A and the location D, the processor 202 may recommend the set of crowdsourcing tasks. Subsequently, the crowdworkers X and Y may attempt the recommended crowdsourcing tasks while traversing their respective paths. As discussed in conjunction with the step 312, the crowdsourcing tasks may be recommended to the crowdworkers X and Y on the display associated with the worker-computing device 102.

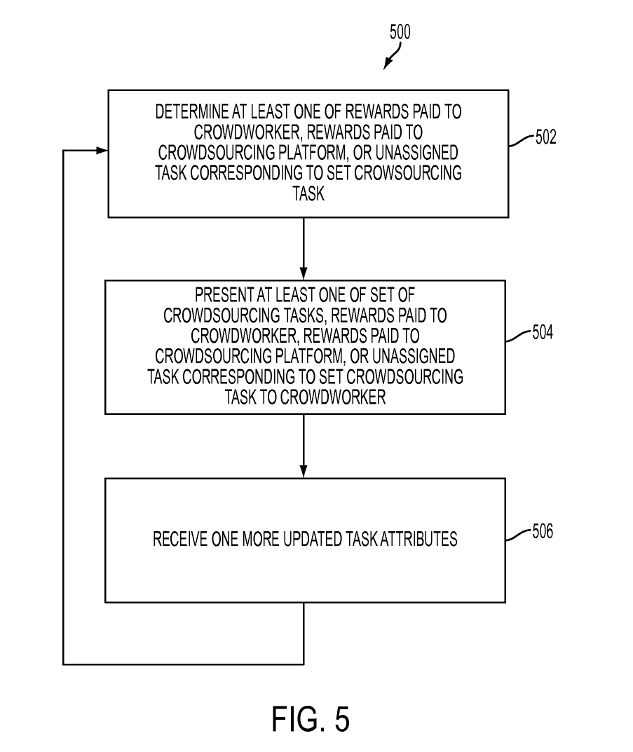

FIG. 5 is a flowchart 500 illustrating a method for updating one or more task attributes, in accordance with at least one embodiment. The flowchart 500 is described in conjunction with FIG. 3 and FIG. 4.

At step 502, at least one of rewards paid to the one or more crowdworkers, rewards paid to the crowdsourcing platform, or unassigned task corresponding to set of crowdsourcing task are determined. The processor 202 determines such information, post determining the set of crowdsourcing tasks for the crowdworker (as disclosed in conjunction with flowchart 300). In an embodiment, the processor 202 may determine the rewards paid to the crowdworkers based on the one or more tasks included in the set of crowdsourcing tasks. For example, if the set of crowdsourcing tasks includes two tasks, each of which rewards crowdworker 5 cents, then the processor 202 may determine that the rewards paid to the crowdworker for the set of crowdsourcing tasks is 10 cents. In a similar way, the rewards paid to the crowdsourcing platform may be determined corresponding to the set of crowdsourcing tasks. In an embodiment, the processor 202 determines the unassigned tasks from the one or more tasks transmitted by the requester. For example, there may be a number of tasks that are not assigned to any of the crowdworkers due to not satisfying location constraints, time constraints, or overhead threshold values.

At step 504, the determined information (i.e. the set of crowdsourcing tasks, rewards paid to the crowdworkers, rewards paid to the crowdsourcing platform, or the unassigned tasks) is presented to the requester. In an embodiment, the processor 202 may present the determined information to the display associated with the requester-computing device 104.

At step 506, the processor 202 receives one or more updated tasks attributes. In an embodiment, the requester, after being presented with the determined information, may choose to update the one or more tasks attributes. That is, the requester may alter the values of the one or more task attributes such as, second spatiotemporal values associated with the crowdsourcing tasks, rewards associated with the crowdsourcing tasks, priority order of the crowdsourcing tasks, and so forth. In an embodiment, the requester may update the task attributes through a knob provided on the requester-computing device 104.

In an embodiment, the steps 502 to 506 may be repeated. That is, the processor 202 may determine updated set of crowdsourcing tasks, updated values of rewards paid to the crowdworkers, updated values of the rewards paid to crowdsourcing platform, and the updated values of the unassigned tasks, based on the received updated tasks attributes. Thereafter, the processor 202 may transmit these updated values to the requester. The steps of altering the values of the one or more tasks attributes, by the requester, may be repeated until he/she is not satisfied with the determined values of set of crowdsourcing tasks, rewards paid to the crowdworkers, rewards paid to the crowdsourcing platform, and the unassigned tasks. In this way, the requester may optimize the task attributes associated with the crowdsourcing tasks, based on his/her requirement.

The disclosed embodiments encompass numerous advantages. The requesters may leverage the lifestyle driven movement patterns of the crowdworkers to recommend crowdsourcing tasks. For example, the requesters may request the crowdworkers to provide the details about queuing delays at movie theatres, about holiday-shopping hours, or about discounts on a set of shops in a shopping-district, while the crowdworkers are traversing for performing their day-to-day activities. Typically, the crowdworkers may pull the crowdsourcing tasks based on their location. For example, a crowdworker, who is waiting at airport, may pull the crowdsourcing tasks based on the location of the airport. Further, the crowdworker may pull the crowdsourcing tasks based on the time constraints of the crowdsourcing tasks. In some of the techniques, the crowdsourcing platforms may recommend the crowdsourcing tasks based on the trip itineraries provided by the crowdworkers. Typically, in those scenarios, the crowdsourcing tasks are recommended without considering the impact on overall set of crowdworkers. However, in the disclosed embodiments the constraint maximization problem is solved such that the overall rewards earned by a group of crowdworkers is maximized. Further, the constraint maximization problem may be solved such that rewards earned by the crowdsourcing platform is maximized. In addition, the constraint maximization problem is solved such that the willingness of the crowdworker to traverse overhead distance/time is taken into account while recommending the crowdsourcing tasks to the crowdworkers. In this way, distribution/recommendation of the crowdsourcing tasks to the crowdworkers is made in an optimized way.

In addition, as disclosed in the various embodiments above, the requesters or task administrators may utilize the disclosed methods and systems to design the one or more task attributes. By presenting various outcomes, such as, but not limited to, the set of crowdsourcing tasks, degree of completeness of the set of crowdsourcing tasks, rewards earned by the crowdworkers/platforms, the requesters may repetitively alter the attributes till the desired outcomes are presented to them.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’, Java, and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for recommending crowdsourcing tasks have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for recommending crowdsourcing tasks for one or more crowdworkers, the method comprising:
predicting, by one or more processors, a path traversed by a crowdworker, from the one or more crowdworkers, based on at least one of a historical data associated with the crowdworker or an input received from the crowdworker, wherein the predicted path traversed by the crowdworker comprises a first set of spatiotemporal values associated with location of the crowdworker;
determining, by the one or more processors, one or more task attributes associated with one or more crowdsourcing tasks, wherein the one or more task attributes comprise at least one of a second set of spatiotemporal values associated with the one or more crowdsourcing tasks, rewards associated with the one or more crowdsourcing tasks, or a number of crowdworkers required to perform each of the one or more crowdsourcing tasks; and
recommending, by the one or more processors, a set of crowdsourcing tasks, from the one or more crowdsourcing tasks, for the crowdworker, based on at least the predicted path followed by each of the one or more crowdworkers and the one or more tasks attributes associated with the one or more crowdsourcing tasks.

2. The method of claim 1 further comprising receiving, by the one or more processors, at least one of a first threshold value of distance for a path associated with the crowdworker or a second threshold value of time, from each crowdworker.

3. The method of claim 2 further comprising determining, by the one or more processors, the set of crowdsourcing tasks based on the first threshold value and the second threshold value.

4. The method of claim 3, wherein the set of crowdsourcing tasks is determined based on a constraint maximization problem that maximizes the rewards earned by the one or more crowdworkers.

5. The method of claim 4, wherein the constraint maximization problem is solved using at least one of a linear programming method or a heuristic technique.

6. The method of claim 4 further comprising ranking, by the one or more processors, the set of crowdsourcing tasks based on at least one of the predicted path followed by the crowdworker, the one or more task attributes, the first threshold value, or the second threshold value.

7. The method of claim 6 further comprising updating, by the one or more processors, the ranked set of crowdsourcing tasks, based on at least movement of the one or more crowdworkers.

8. The method of claim 1, wherein the rewards associated with the one or more crowdsourcing tasks correspond to at least one of the rewards earned by the crowdworker in performing the one or more crowdsourcing tasks or the rewards earned by a crowdsourcing platform when the crowdworker performs the one or more crowdsourcing tasks.

9. The method of claim 1, wherein the one or more tasks attributes further comprise a frequency at which the crowdworker performs the one or more crowdsourcing tasks.

10. The method of claim 1, wherein the one or more crowdsourcing tasks comprise at least one of providing queuing delay information, providing discount information, providing information about rush, image/video/text labelling/tagging/categorisation, data entry, product description writing, product review writing, address look-up, survey completion, consumer feedback, or targeted photography.

11. The method of claim 1, wherein the historical data comprises information pertaining to previously traversed paths, by the one or more crowdworkers.

12. The method of claim 1, wherein the second set of spatiotemporal values comprises information pertaining to location constraints and time constraints associated with the one or more crowdsourcing tasks.

13. A method implementable in a crowdsourcing platform, the method comprising:
predicting, by one or more processors, a path traversed by a crowdworker, from one or more crowdworkers, based on at least one of a historical data associated with the crowdworker or an input received from the crowdworker, wherein the predicted path traversed by the crowdworker comprises a first set of spatiotemporal values associated with location of the crowdworker;
receiving, by the one or more processors, one or more task attributes associated with one or more crowdsourcing tasks, wherein the one or more task attributes comprise at least one of a second set of spatiotemporal values associated with the one or more crowdsourcing tasks, rewards associated with the one or more crowdsourcing tasks, or a number of crowdworkers required to perform each of the one or more crowdsourcing tasks; and
presenting, by the one or more processors, at least one of a set of crowdsourcing tasks, from the one or more crowdsourcing tasks, for the crowdworker, rewards earned by the one or more crowdworkers, a degree of completeness of the set of crowdsourcing tasks, based on at least the predicted path followed by each of the one or more crowdworkers and the one or more tasks attributes associated with the one or more crowdsourcing tasks.

14. The method of claim 13, wherein the one or more task attributes further comprise a priority order of the one or more crowdsourcing tasks for the one or more crowdworkers.

15. The method of claim 13 further comprising receiving, by the one or more processors, one or more updated task attributes based on the presentation.

16. A system for recommending crowdsourcing tasks for one or more crowdworkers, the system comprising:
one or more processors operable to:
predict a path traversed by a crowdworker, from the one or more crowdworkers, based on at least one of a historical data associated with the crowdworker or an input received from the crowdworker, wherein the predicted path traversed by the crowdworker comprises a first set of spatiotemporal values associated with location of the crowdworker;
determine one or more task attributes associated with one or more crowdsourcing tasks, wherein the one or more task attributes comprise at least one of a second set of spatiotemporal values associated with the one or more crowdsourcing tasks, rewards associated with the one or more crowdsourcing tasks, or a number of crowdworkers required to perform each of the one or more crowdsourcing tasks; and
recommend a set of crowdsourcing tasks, from the one or more crowdsourcing tasks, for the crowdworker, based on at least the predicted path followed by each of the one or more crowdworkers and the one or more tasks attributes associated with the one or more crowdsourcing tasks.

17. The system of claim 16, wherein the one or more processors are further operable to receive at least one of a first threshold value of distance for a path associated with the crowdworker or a second threshold value of time, from each crowdworker.

18. The system of claim 17, wherein the one or more processors are further operable to determine the set of crowdsourcing tasks based on the first threshold value and the second threshold value.

19. The system of claim 18, wherein the set of crowdsourcing tasks is determined based on a constraint maximization problem that maximizes the rewards earned by the one or more crowdworkers.

20. The system of claim 19, wherein the constraint maximization problem is solved using at least one of a linear programming method or a heuristic technique.

21. The system of claim 19, wherein the one or more processors are further operable to rank the set of crowdsourcing tasks based on at least one of the predicted path followed by the crowdworker, the one or more task attributes, the first threshold value, or the second threshold value.

22. The system of claim 21, wherein the one or more processors are further operable to update the ranked set of crowdsourcing tasks, based on at least movement of the one or more crowdworkers.

23. The system of claim 16, wherein the rewards associated with the one or more crowdsourcing tasks correspond to at least one of the rewards earned by the crowdworker in performing the one or more crowdsourcing tasks or the rewards earned by a crowdsourcing platform when the crowdworker performs the one or more crowdsourcing tasks.

24. The system of claim 16, wherein the one or more tasks attributes further comprise a frequency at which the crowdworker performs the one or more crowdsourcing tasks.

25. The system of claim 16, wherein the one or more crowdsourcing tasks comprise at least one of providing queuing delay information, providing discount information, providing information about rush, image/video/text labelling/tagging/categorisation, data entry, product description writing, product review writing, address look-up, survey completion, consumer feedback, or targeted photography.

26. The system of claim 16, wherein the historical data comprises information pertaining to previously traversed paths, by the one or more crowdworkers.

27. The system of claim 16, wherein the second set of spatiotemporal values comprises information pertaining to location constraints and time constraints associated with the one or more crowdsourcing tasks.

28. A computer program product for use with a computer, the computer program product comprising a non-transitory computer readable medium, wherein the non-transitory computer readable medium stores a computer program code for recommending crowdsourcing tasks for one or more crowdworkers, wherein the computer program code is executable by one or more processors to:
predict a path traversed by a crowdworker, from the one or more crowdworkers, based on at least one of a historical data associated with the crowdworker or an input received from the crowdworker, wherein the predicted path traversed by the crowdworker comprises a first set of spatiotemporal values associated with location of the crowdworker;
determine one or more task attributes associated with one or more crowdsourcing tasks, wherein the one or more task attributes comprise at least one of a second set of spatiotemporal values associated with the one or more crowdsourcing tasks, rewards associated with the one or more crowdsourcing tasks, or a number of crowdworkers required to perform each of the one or more crowdsourcing tasks; and
recommend a set of crowdsourcing tasks, from the one or more crowdsourcing tasks, for the crowdworker, based on at least the predicted path followed by each of the one or more crowdworkers and the one or more tasks attributes associated with the one or more crowdsourcing tasks.
